(19) United States
(12) Patent Application Publication
(10) Pub. No.: US 2026/0012211 A1
(43) Pub. Date: Jan. 8, 2026

(54) RADIO COMMUNICATION APPARATUS AND ESTIMATION METHOD

(71) Applicant: 1FINITY Inc., Kawasaki-shi (JP)

(72) Inventors: Akihiko KOMATSUZAKI, Kawasaki (JP); Katsunao TAKAHASHI, Otsu (JP); Mitsuharu HAMANO, Sendai (JP)

(73) Assignee: 1FINITY Inc., Kawasaki-shi (JP)

(21) Appl. No.: 19/328,813

(22) Filed: Sep. 15, 2025

Related U.S. Application Data
(63) Continuation of application No. PCT/JP2024/004709, filed on Feb. 13, 2024.

(30) Foreign Application Priority Data
Mar. 17, 2023 (JP) 2023-043542

(51) Int. Cl. H04B 1/04

(52) U.S. Cl. CPC H04B 1/0475

(57) ABSTRACT

A radio communication apparatus includes a transmission signal acquisition unit, a reception signal acquisition unit, a storage unit, a calculation unit and an estimation unit. The transmission signal acquisition unit acquires a plurality of transmission signals wirelessly transmitted at different frequencies. The reception signal acquisition unit acquires a reception signal. The storage unit stores reference power and a reference correlation gain. The calculation unit generates a replica signal of an intermodulation distortion signal based on the plurality of transmission signals and calculates a correlation gain based on a correlation between the replica signal and the reception signal. The estimation unit that estimates the intermodulation distortion signal based on the correlation gain calculated by the calculation unit and the reference power and the reference correlation gain stored in the storage unit.

### CROSS-REFERENCE TO RELATED APPLICATIONS

This application is a continuation of International Application No. PCT/JP2024/004709, filed on Feb. 13, 2024, which claims the benefit of priority of the prior Japanese Patent Application No. 2023-043542, filed on Mar. 17, 2023, the entire contents of which are incorporated herein by reference.

### FIELD

The embodiments discussed herein are related to a radio communication apparatus and an estimation method.

### BACKGROUND

In recent years, various signals having different frequencies have been transmitted inside and outside a radio communication apparatus such as a base station device of a radio communication system. Here, when a distortion-generating source such as metal is present on a transmission path of the signals, intermodulation distortion, that is, passive intermodulation (PIM) is generated due to intermodulation of the signals having different frequencies. That is, a PIM signal having a frequency of a sum or a difference of multiples of the frequencies of the signals is generated in the distortion-generating source.

The base station device includes, for example, a central unit (CU)/a distributed unit (DU) and a radio unit (RU). FIG. 11 is an explanatory diagram illustrating an example of a configuration of an RU 200 of the related arts. The RU 200 illustrated in FIG. 11 includes an antenna 200A, an interface 200B, and a processor 200C. The interface 200B includes a digital analog convertor (DAC) 211, an up-converter 212, and a power amplifier (PA) 213 for each transmission signal Tx. The interface 200B includes a band pass filter (BPF) 216, a low noise amplifier (LNA) 217, a down-converter 218, and an analog digital convertor (ADC) 219 for each reception signal. The interface 200B includes a multiplexing unit 214 and a duplexer 215. The duplexer 215 connects the multiplexing unit 214 to the antenna 200A and connects the BPF 216 to the antenna 200A. The duplexer 215 outputs a transmission signal from the multiplexing unit 214 to the antenna 200A and outputs a reception signal received from the antenna 200A to the BPF 216.

The DAC 211 performs analog conversion of a baseband frequency transmission signal from the processor 200C and outputs a transmission signal after analog conversion to the up-converter 212. The up-converter 212 up-converts a radio frequency of the transmission signal after analog conversion and outputs a transmission signal after up-conversion to the PA 213. The PA 213 amplifies the transmission signal after up-conversion and outputs an amplified transmission signal to the multiplexing unit 214. The multiplexing unit 214 multiplexes transmission signals from each of the PAs 213 and outputs a multiplexed transmission signal to the duplexer 215. The duplexer 215 outputs the transmission signal from the multiplexing unit 214 to the antenna 200A. The antenna 200A wirelessly outputs the transmission signal from the duplexer 215.

The antenna 200A receives an incoming radio reception signal. The duplexer 215 outputs the reception signal received from the antenna 200A to the BPF 216. The BPF 216 extracts a reception signal of a reception band from the reception signal. The LNA 217 amplifies the reception signal extracted by the BPF 216 and outputs an amplified reception signal to the down-converter 218. The down-converter 218 down-converts the amplified reception signal into a baseband frequency and outputs a reception signal after down-conversion to the ADC 219. The ADC 219 digitally converts the reception signal after down-conversion and outputs a reception signal after digital conversion to the processor 200C. Here, it is assumed that a PIM signal generated by intermodulation of signals of frequencies f1 and f2 of the transmission signal is added to the reception signal as described below.

The PIM signal is generated, for example, at a junction of two different types of metals and generated in a cable or a connector that connects the RU 200 to the antenna 200A. When the frequency of the PIM signal is included in the reception frequency band of the RU 200, sensitivity of the reception signal deteriorates and uplink characteristics are affected by the PIM signal.

Therefore, for example, a PIM signal by intermodulation of transmission signals having different frequencies transmitted from the RU 200 is approximately reproduced, and the PIM signal added to the reception signal is canceled out. A PIM signal generated from a plurality of transmission signals having different frequencies can be estimated by calculation. Therefore, a replica signal is used to cancel the PIM signal. The replica signal is a replica of the PIM signal and is a signal having the same amplitude and the opposite phase with respect to the PIM signal. In the RU 200, cancellation of the PIM signal added to a reception signal is realized by superimposing (adding) the replica signal on the reception signal.

The related technologies are described, for example, in Japanese Laid-open Patent Publication No. 2015-233279, and in Japanese Laid-open Patent Publication No. 2017-130718.

However, in the RU 200 of the related arts, to prevent sensitivity deterioration of a reception signal and an influence on uplink characteristics by a PIM signal, a generation amount of the PIM signal needs to be monitored even during operation. Note that “during operation” is a state in which the RU 200 as a radio system is providing a service of radio communication between UEs for a user of the UE.

FIG. 12 is an explanatory diagram illustrating an example of frequency characteristics of an actual PIM signal and a replica signal before and after passing an analog filter. During multi-carrier transmission in the RU 200 of the related arts, a PIM signal is generated in a wider band than a reception band. However, in the reception signal to which the PIM signal is added, it is possible to suppress the PIM signal generated in a wide band using an analog filter such as the duplexer 215 in the RU 200 or the BPF 216 in a reception circuit.

However, in the RU 200, since frequency characteristics of the reception signal are significantly changed before and after passing the analog filter, when the reception signal after passing the analog filter is used, it is difficult to obtain a correlation between the PIM replica signal and the reception signal. As a result, a generation amount (power value) of the PIM signal significantly deviates.

In the RU 200 of the related arts, since the reception signal and the PIM signal overlap each other during operation, the PIM signal needs to be discriminated and estimated from the reception signal, but it is difficult to estimate the generation amount of the PIM signal during operation.

### SUMMARY

According to an aspect of an embodiment, a radio communication apparatus includes a transmission signal acquisition unit, a reception signal acquisition unit, a storage unit, a calculation unit and an estimation unit. The transmission signal acquisition unit acquires a plurality of transmission signals wirelessly transmitted at different frequencies. The reception signal acquisition unit acquires a reception signal. The storage unit stores reference power and a reference correlation gain. The calculation unit generates a replica signal of an intermodulation distortion signal based on the plurality of transmission signals and calculates a correlation gain based on a correlation between the replica signal and the reception signal. The estimation unit that estimates the intermodulation distortion signal based on the correlation gain calculated by the calculation unit and the reference power and the reference correlation gain stored in the storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a configuration of a radio system of the present embodiment;

FIG. 2 is an explanatory diagram illustrating an example of a configuration of an RU;

FIG. 3 is a block diagram illustrating an example of a functional configuration in a processor in the RU;

FIG. 4A is an explanatory diagram illustrating an example of frequency characteristics of an actual PIM signal and a replica signal before filter coefficient multiplication;

FIG. 4B is an explanatory diagram illustrating an example of frequency characteristics of the actual PIM signal and the replica signal after filter coefficient multiplication;

FIG. 5 is an explanatory diagram illustrating an example of the RU under a training environment;

FIG. 6 is a flowchart illustrating an example of a processing operation of the processor in the RU related to estimation processing;

FIG. 7 is a flowchart illustrating an example of the processing operation of the processor in the RU related to first calculation processing;

FIG. 8 is a flowchart illustrating an example of the processing operation of the processor in the RU related to first arithmetic processing;

FIG. 9 is a flowchart illustrating an example of the processing operation of the processor in the RU related to second arithmetic processing;

FIG. 10 is an explanatory diagram illustrating an example of a hardware configuration of the RU;

FIG. 11 is an explanatory diagram illustrating an example of a configuration of an RU of the related arts; and

FIG. 12 is an explanatory diagram illustrating an example of frequency characteristics of an actual PIM signal and a replica signal before and after passing an analog filter.

### DESCRIPTION OF EMBODIMENTS

Preferred embodiments of the present invention will be explained with reference to accompanying drawings. Note that the present invention is not limited to the following embodiments.

### Configuration of Radio Communication System

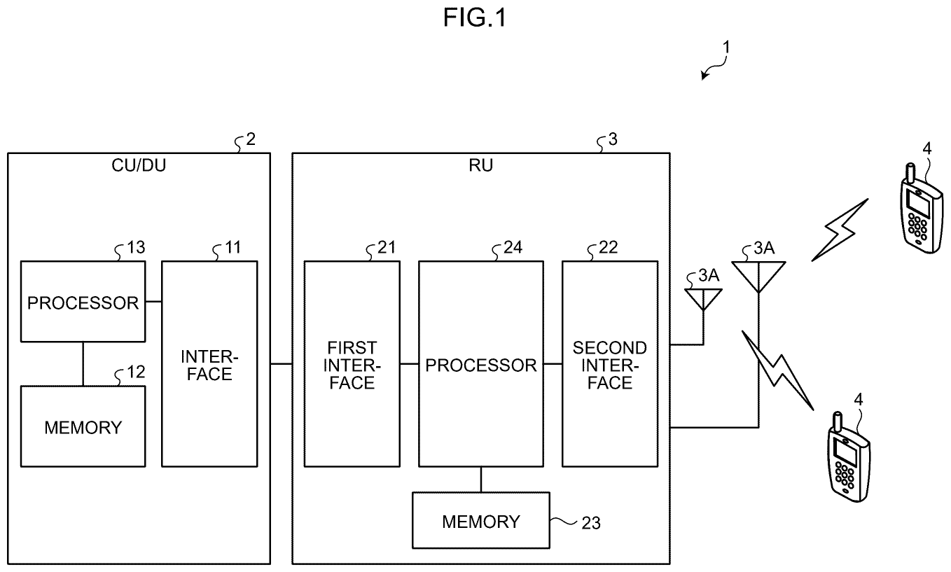

FIG. 1 is an explanatory diagram illustrating an example of a radio system 1 of the present embodiment. The radio system 1 illustrated in FIG. 1 is, for example, a radio system of a SUB6 frequency band. The radio system 1 includes a centralized unit (CU)/distributed unit (DU) 2, a radio unit (RU) 3, and user equipment (UE) 4. A radio access network (RAN) interface between the RU 3 and the UE 4 is interoperable across a plurality of carrier operators. The RU 3 is an example of the radio communication apparatus. Note that the CU/DU 2 and the RU 3 may be collectively expressed as one radio communication apparatus.

The CU/DU 2 is connected to a core network (not illustrated) and performs baseband processing on data transmitted to the UE 4 and data received from the UE 4. The CU/DU 2 communicates with each UE 4 via the RU 3. Note that data may be data of different carrier operators transmitted from different CUs/DUs 2 or may be data of the same carrier operator transmitted from one CU/DU 2. The CU/DU 2 may be configured by one device in which a CU and a DU are integrated or may be configured by a plurality of devices in which a CU and a DU are provided separately. The CU/DU 2 and the RU 3 function as base station devices of the radio system 1.

The RU 3 performs RF processing on data transmitted to the UE 4 and data received from the UE 4. Specifically, the RU 3 receives band data having different frequency bands from the CU/DU 2, performs RF processing on the band data, and transmits the band data to the UE 4.

The CU/DU 2 performs baseband processing and transmits a baseband signal including transmission data to the RU 3. The CU/DU 2 receives a baseband signal including reception data from the RU 3 and performs baseband processing on the baseband signal. Specifically, the CU/DU 2 includes an interface 11, a memory 12, and a processor 13.

The processor 13 includes, for example, a central processing unit (CPU), a field programmable gate array (FPGA) or a digital signal processor (DSP), and the like, and generates a transmission signal. In the present embodiment, a case in which the RU 3 transmits transmission signals at frequencies f1 and f2 different from each other from antennas 3A will be described as an example. Therefore, the processor 13 generates transmission signals Tx1 and Tx2 transmitted from each of the two antennas 3A of the RU 3. The processor 13 obtains reception data from a reception signal received by the RU 3.

The memory 12 includes, for example, a random access memory (RAM), a read only memory (ROM), and the like, and stores information used by the processor 13 to execute processing.

The interface 11 is connected to the RU 3 by, for example, an optical fiber or the like and transmits and receives a baseband signal to and from the RU 3. The baseband signal transmitted by the interface 11 includes the above-described transmission signals Tx1 and Tx2.

The RU 3 has a function of detecting an intermodulation distortion signal (PIM signal) added to the reception signal based on the transmission signals Tx1 and Tx2. Note that high-order distortion (for example, third-order distortion) of the intermodulation distortion signal and the like may be generated from a plurality of transmission signals, for example, the transmission signals Tx1 and Tx2 having different frequencies. In the present embodiment, a distortion-generating source is irradiated with the transmission signals Tx1 and Tx2 as high-order distortion and generates a PIM signal, and a frequency of the PIM signal is included in a reception frequency band of the RU 3. That is, the RU 3 has a function of detecting the PIM signal generated by intermodulation of the transmission signals Tx1 and Tx2 from the reception signal.

The RU 3 includes a first interface 21, a second interface 22, a memory 23, and a processor 24.

The first interface 21 is a communication interface that is connected to the CU/DU 2 and transmits and receives the baseband signal to and from the CU/DU 2. That is, the first interface 21 receives the transmission signal from the interface 11 of the CU/DU 2. The first interface 21 transmits the reception signal to the interface 11 of the CU/DU 2.

The processor 24 includes, for example, a CPU, an FPGA, a DSP, and the like, and generates a replica signal for detecting the PIM signal based on a plurality of transmission signals received by the first interface 21. The replica signal is a replica of the PIM signal generated by the intermodulation of a plurality of transmission signals (for example, the transmission signals Tx1 and Tx2) and is a signal having the same amplitude and the opposite phase with respect to the PIM signal. The replica signal is generated by calculation. The function of the processor 24 is described in detail below.

The memory 23 includes, for example, a RAM, a ROM, and the like, and stores information used by the processor 24 to execute processing. That is, the memory 23 stores, for example, a parameter used when the processor 24 generates the replica signal and a reference power, a reference correlation gain, and the like described below used to estimate the generation amount of the PIM signal.

The second interface 22 is connected to the antenna 3A, for example, and transmits and receives the transmission signal and the reception signal to and from the antenna 3A. That is, the second interface 22 transmits the transmission signal received from the processor 24 to the antenna 3A. The second interface 22 receives the reception signal received by the antenna 3A from the antenna 3A. The PIM signal generated by the intermodulation of a signal of the frequency f1 and a signal of the frequency f2 is added to the reception signal received from the antenna 3A by the second interface 22.

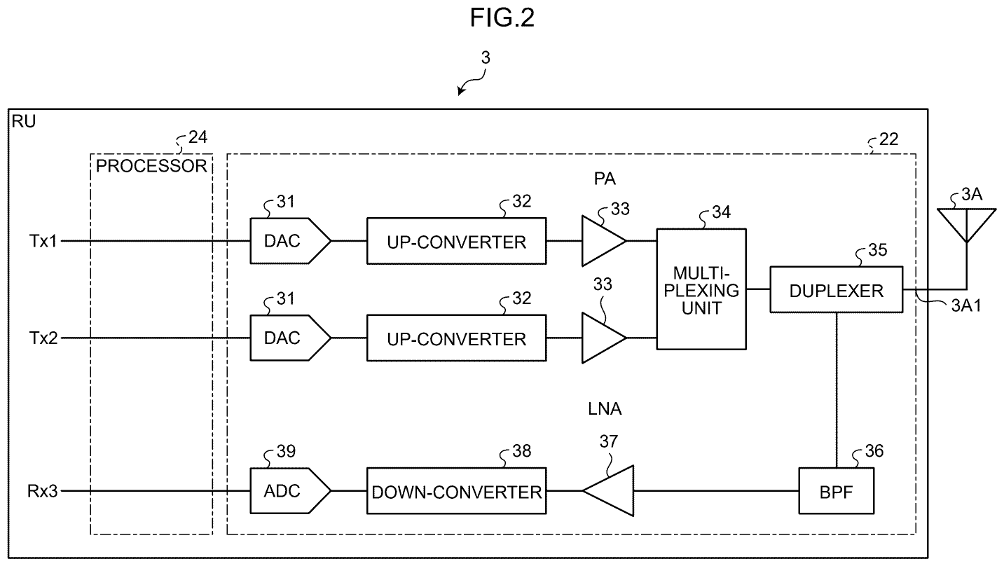

FIG. 2 is an explanatory diagram illustrating an example of a configuration of the RU 3. The second interface 22 in the RU 3 illustrated in FIG. 2 includes a digital analog converter (DAC) 31, an up-converter 32, and a power amplifier (PA) 33 for each transmission signal. The second interface 22 includes a band pass filter (BPF) 36, a low noise amplifier (LNA) 37, a down-converter 38, and an analog digital converter (ADC) 39 for each reception signal. The second interface 22 includes a multiplexing unit 34 and a duplexer 35. The duplexer 35 connects the multiplexing unit 34 to the antenna 3A and connects the BPF 36 to the antenna 3A. The duplexer 35 outputs a transmission signal from the multiplexing unit 34 to the antenna 3A and outputs a reception signal received from the antenna 3A to the BPF 36. The second interface 22 in the RU 3 is connected to the duplexer 35 via an antenna port 3A1.

The DAC 31 performs analog conversion on a transmission signal of a baseband signal from the processor 24 and outputs the transmission signal after analog conversion to the up-converter 32. The up-converter 32 up-converts a radio frequency of the transmission signal after analog conversion, and outputs a transmission signal after up-conversion to the PA 33. The PA 33 amplifies the transmission signal after up-conversion and outputs an amplified transmission signal to the multiplexing unit 34. The multiplexing unit 34 multiplexes transmission signals from each of the PAs 33. The duplexer 35 outputs a multiplexed transmission signal from the multiplexing unit 34 to the antenna 3A. The antenna 3A wirelessly outputs the transmission signal from the duplexer 35.

The antenna 3A receives an incoming radio reception signal. The duplexer 35 outputs the reception signal received from the antenna 3A to the BPF 36. The BPF 36 extracts a reception signal of a reception band from the reception signal. The LNA 37 amplifies the reception signal extracted by the BPF 36 and outputs an amplified reception signal to the down-converter 38. The down-converter 38 down-converts the amplified reception signal into a baseband frequency and outputs a reception signal after down-conversion to the ADC 39. The ADC 39 digitally converts the reception signal after down-conversion and outputs a reception signal after digital conversion to the processor 24. It is assumed that the PIM signal generated by the intermodulation of the transmission signals of the frequencies f1 and f2 is added to the reception signal.

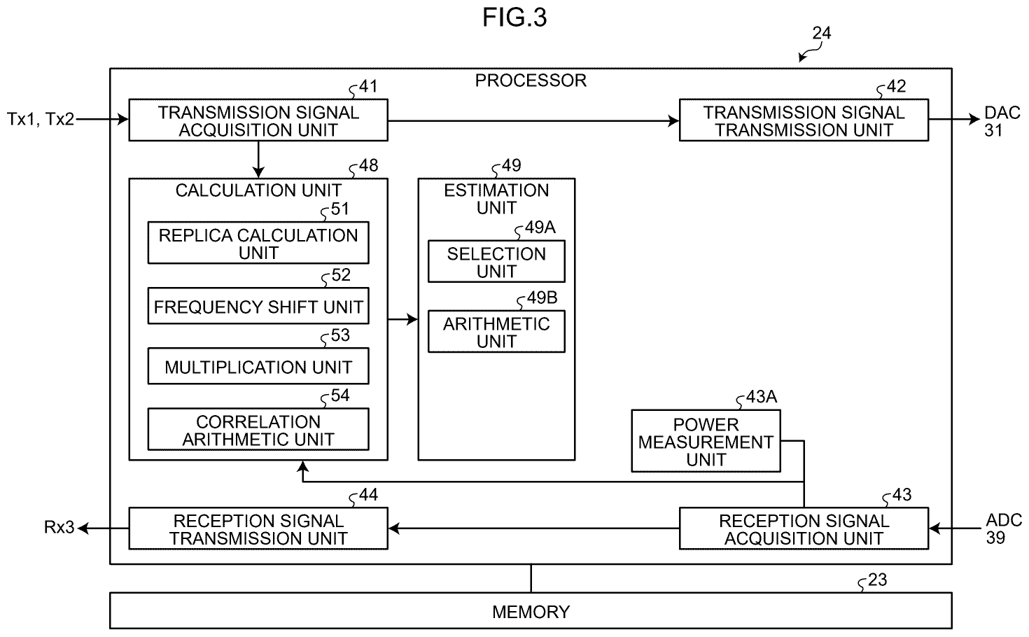

FIG. 3 is a block diagram illustrating an example of a functional configuration in the processor 24 in the RU 3. The processor 24 illustrated in FIG. 3 includes a transmission signal acquisition unit 41, a transmission signal transmission unit 42, a reception signal acquisition unit 43, and a reception signal transmission unit 44. The processor 24 includes a power measurement unit 43A, a calculation unit 48, and an estimation unit 49.

The transmission signal acquisition unit 41 acquires a transmission signal received from the CU/DU 2 by the first interface 21. That is, the transmission signal acquisition unit 41 acquires, for example, the transmission signals Tx1 and Tx2.

The transmission signal transmission unit 42 outputs the transmission signals acquired by the transmission signal acquisition unit 41 to the second interface 22. Specifically, the transmission signal transmission unit 42 outputs the transmission signals Tx1 and Tx2 to the second interface 22.

The reception signal acquisition unit 43 acquires a reception signal received from the antenna 3A by the second interface 22. For example, the PIM signal generated by the intermodulation of the transmission signals Tx1 and Tx2 is added to the reception signal acquired by the reception signal acquisition unit 43. The power measurement unit 43A measures reception power of the reception signal via the reception signal acquisition unit 43.

The reception signal transmission unit 44 receives the reception signal output from the reception signal acquisition unit 43. The reception signal transmission unit 44 outputs the reception signal to the CU/DU 2 via the first interface 21.

The calculation unit 48 generates a replica signal of the PIM signal based on a plurality of transmission signals, and calculates a correlation gain based on a correlation between the replica signal and the reception signal. The calculation unit 48 calculates a correlation gain of the PIM signal based on an IQ signal before input of the DAC 31 of the transmission signals Tx1 and Tx2 acquired by the transmission signal acquisition unit 41 and an IQ signal after output of the ADC 39 of a reception signal Rx3 acquired by the reception signal acquisition unit 43.

The calculation unit 48 includes a replica calculation unit 51, a frequency shift unit 52, a multiplication unit 53, and a correlation arithmetic unit 54.

The replica calculation unit 51 calculates a replica signal using (Formula 1) based on the IQ signal before input of the DAC 31 of the transmission signals Tx1 and Tx2 acquired by the transmission signal acquisition unit 41. (Formula 1) represents a replica signal of an intermodulation distortion component of a frequency (2f1-f2) generated from the transmission signals Tx1 and Tx2. Note that Tx1 and Tx2 can be interchanged, and Rep is used as a frequency overlapping a reception frequency.

$$Rep [ n ] = {IQ}_{Tx 1} [ n ] * {IQ}_{Tx 1} [ n ] * conj ( {IQ}_{Tx 2} [ n ] )$$

$${IQ}_{Tx 1} , {IQ}_{Tx 2} , {IQ}_{Rx 3} : IQ signals of Tx 1 , Tx 2 , Rx 3$$

conj: complex conjugate
n: sample number of IQ signal

The frequency shift unit 52 frequency-shifts the replica signal and the reception signal to align a center frequency of the replica signal and a center frequency of the reception signal on the baseband processing. The replica signal after frequency shift can be expressed by (Formula 2).

$${Rep}^{′} [ n ] = Rep [ n ] * exp ( j * φ [ n ] )$$

φ[n]: frequency shift amount of replica signal

The reception signal after frequency shift can be expressed by (Formula 3).

$${IQ}_{Rx 3}^{′} [ n ] = {IQ}_{Rx 3} [ n ] * exp ( j * θ [ n ] )$$

θ[n]: frequency shift amount of RX signal

The multiplication unit 53 removes a band component outside a reception band from the replica signal after frequency shift and the reception signal after frequency shift by multiplying both the replica signal after frequency shift and the reception signal after frequency shift by a filter coefficient. Note that the PIM signal is generated in a wide band during multicarrier transmission or the like, but when the band is wider than the reception band, it is difficult to obtain a correlation with the replica signal of the PIM signal because the PIM signal passes an analog filter in a reception circuit.

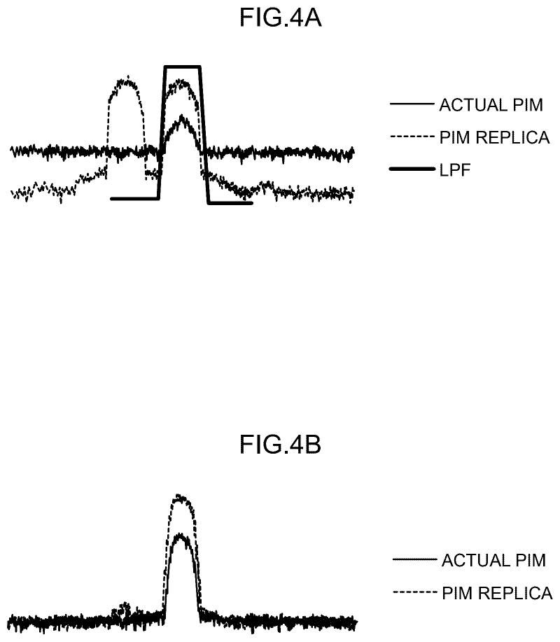

FIG. 4A is an explanatory diagram illustrating an example of frequency characteristics of an actual PIM signal and a replica signal before filter coefficient multiplication. FIG. 4B is an explanatory diagram illustrating an example of frequency characteristics of the actual PIM signal and the replica signal after filter coefficient multiplication. As illustrated in FIGS. 4A and 4B, both a replica signal and a reception signal are multiplied by the same filter coefficient to remove a band component outside a reception band, whereby a correlation between the replica signal of the reception band and the reception signal can be obtained.

The multiplication unit 53 multiplies a replica signal after frequency shift by a filter coefficient and calculates a replica signal after filter coefficient multiplication. The replica signal after multiplication can be expressed by (Formula 4).

$${Rep}^{″} [ n ] = {\sum }_{m = 0}^{M} {LPF}_{m} * {Rep}^{′} [ n - m ]$$

n: sample number of IQ signal
N: total number of samples of IQ signal
m: sample number of digital filter
M: total number of samples of digital filter
LPFₘ:LPF (digital filter) coefficient of m-th sample

The reception signal after multiplication can be expressed by (Formula 5).

$${IQ}_{Rx 3}^{″} [ n ] = {\sum }_{m = 0}^{M} {LPF}_{m} * {IQ}_{Rx 3}^{′} [ n - m ]$$

The correlation arithmetic unit 54 calculates replica power based on the replica signal after multiplication. The replica power can be expressed by (Formula 6).

$${Rep}_{Pow ( d )} = \vert {\sum }_{n = 0}^{N - 1} \{ {Rep}^{″} ( n + d ) \} \vert$$

n: sample number of IQ signal
N: total number of samples of IQ signal
d: delay difference between extraction position of Tx1(n) and Tx2(n) and extraction position of Rx3(n)

The correlation arithmetic unit 54 calculates a correlation gain of the PIM signal based on the replica signal after multiplication and the reception signal after multiplication. The correlation arithmetic unit 54 calculates a correlation value between the replica signal after multiplication and the reception signal after multiplication using (Formula 7).

$$Corr ( d ) = {\sum }_{n = 0}^{N - 1} \{ {IQ}_{RX 3}^{″} ( n ) \times conj ( {Rep}^{″} ( n + d ) ) \}$$

The correlation arithmetic unit 54 calculates correlation power using (Formula 8) that is an absolute value of the correlation value.

$${Corr}_{Pow} ( d ) = \vert Corr ( d ) \vert$$

The correlation arithmetic unit 54 calculates a correlation gain using (Formula 9) based on the correlation power and the replica power.

$${Corr}_{Gain} ( d ) = \frac{{Corr}_{Pow} ( d )}{{Rep}_{Pow} ( d )}$$

That is, the correlation arithmetic unit 54 sequentially calculates the correlation gain for each delay difference. Then, the estimation unit 49 estimates a PIM power value that is a generation amount of the PIM signal based on the correlation gain, the reference correlation gain, and the reference power. The estimation unit 49 includes a selection unit 49A and an arithmetic unit 49B.

The selection unit 49A selects a correlation gain having a maximum value from the correlation gains sequentially calculated for each delay difference. A delay difference d is a time difference between the transmission signals Tx1 and Tx2 and the reception signal Rx3. The delay difference varies depending on a path length to a generation point of PIM. Therefore, the correlation gain is calculated for each delay difference in the range of d=0 to dmax. The maximum correlation gain d is a delay difference of a path from transmission (extraction position of transmission signal) passing a PIM generation point to reception (extraction position of reception signal).

The arithmetic unit 49B estimates the generation amount of the PIM signal based on the correlation gain calculated by the calculation unit 48 and the reference power and the reference correlation gain stored in the memory 23. The reference power is power obtained by subtracting noise power of the reception circuit from the reception power measured by the power measurement unit 43A under a training environment of the RU 3 described below. The reference correlation gain is a correlation gain for each delay difference calculated under the training environment of the RU 3.

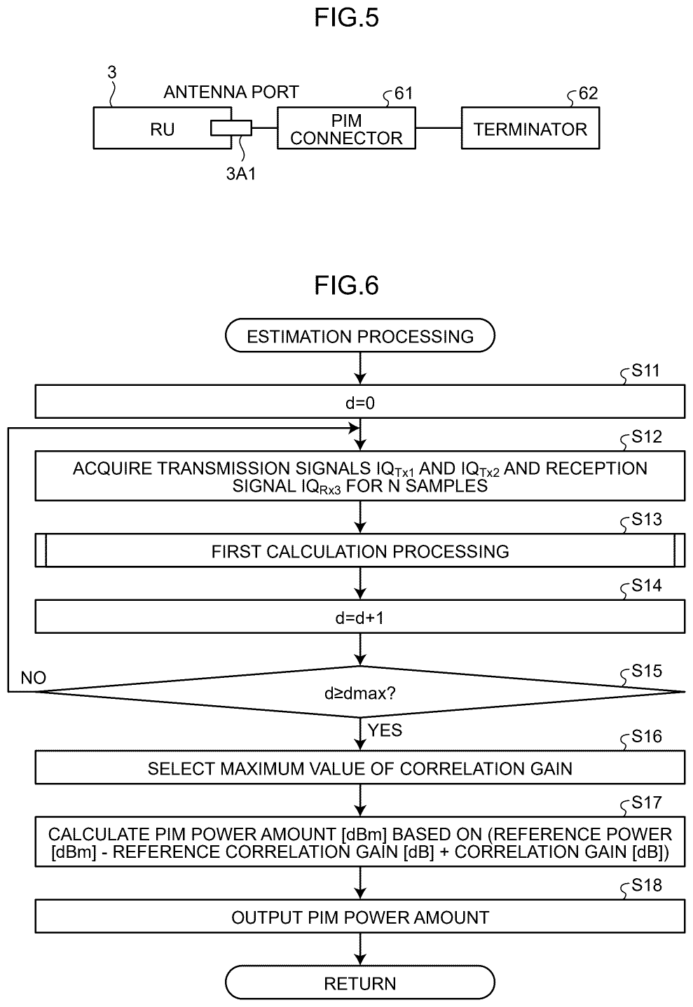

A method of calculating the reference power and the reference correlation gain stored in the memory 23 will be described. FIG. 5 is an explanatory diagram illustrating an example of the RU 3 under the training environment. The RU 3 performs training by connecting a PIM connector 61 connected to a terminator 62 to the antenna port 3A1 of the second interface 22. The PIM connector 61 is a connector that generates a predetermined PIM signal. The processor 24 in the RU 3 connects the PIM connector 61 connected to the terminator 62 to the antenna port 3A1, so that only a predetermined PIM signal generated in the PIM connector 61 is input as the reception signal. The processor 24 sequentially calculates a correlation gain for each delay difference as the reference correlation gain based on the reception signal of only the PIM signal. The processor 24 sequentially calculates the correlation gain calculated under the training environment for each delay difference d, and stores the maximum value of the correlation gain as the reference correlation gain in the memory 23.

The power measurement unit 43A measures reception power measured under the training environment. Then, the processor 24 calculates the reference power based on (reception power-noise power). Note that the noise power is calculated by NF*k*T*B based on noise figure (NF) of the reception circuit in the RU 3 and thermal noise kTB. k is a Boltzmann constant, T is an absolute temperature, and B is a frequency band of the reception circuit in the RU 3. Then, the processor 24 stores the reference power calculated under the training environment in the memory 23.

When the correlation gain having the maximum value is selected, the selection unit 49A selects a delay difference of the selected correlation gain having the maximum value.

Based on the correlation gain of the maximum value, the reference power, and the reference correlation gain, in true number calculation, the arithmetic unit 49B calculates a PIM power amount that is a generation amount of the PIM signal using (reference power−reference correlation gain+correlation gain). In dB calculation, the arithmetic unit 49B calculates the PIM power amount (dBm) using reference power (dBm)−reference correlation gain (dB)+correlation gain (dB). Then, the processor 24 notifies the CU/DU 2 of the PIM power amount calculated during operation via the first interface 21. As a result, the carrier operator of the CU/DU 2 can confirm the generation amount of the PIM signal (PIM power amount) of the RU 3 during operation. Note that “during operation” is a state in which the RU 3 as the radio system 1 is providing a service of radio communication between the UEs 4 to a user of the UE 4.

Next, the operation of the RU 3 of the present embodiment will be described. FIG. 6 is a flowchart illustrating an example of a processing operation of the processor 24 in the RU 3 related to estimation processing. The estimation processing is processing for estimating the generation amount of the PIM signal even during operation.

The processor 24 sets delay difference d=0 (step S11). The processor 24 acquires IQ signals of the transmission signals Tx1 and Tx2 and an IQ signal of the reception signal Rx3 for N samples corresponding to the set delay difference d (step S12). The transmission signal acquisition unit 41 acquires the IQ signals of the transmission signals Tx1 and Tx2 for the N samples corresponding to the set delay difference d. The reception signal acquisition unit 43 acquires the IQ signal of the reception signal Rx3 for the N samples corresponding to the set delay difference d.

The processor 24 executes first calculation processing of calculating the correlation gain corresponding to the set delay difference d based on the acquired IQ signals of the transmission signals Tx1 and Tx2 and the acquired IQ signal of the reception signal Rx3 (step S13). The processor 24 increments the set delay difference d by +1 (step S14) and determines whether the set delay difference d is equal to or larger than the maximum delay difference dmax (step S15).

When the set delay difference d is not equal to or larger than the maximum delay difference dmax (step S15: No), the processor 24 proceeds to the processing in step S12 to acquire the IQ signals of the transmission signals Tx1 and Tx2 and the IQ signal of the reception signal Rx3 for the N samples corresponding to the set delay difference d.

When the set delay difference d is equal to or larger than the maximum delay difference dmax (step S15: Yes), the selection unit 49A in the processor 24 selects the correlation gain having the maximum value among the correlation gains for each set delay difference d (step S16).

The arithmetic unit 49B in the processor 24 calculates the PIM power amount (dBm) based on the correlation gain having the maximum value, the reference correlation gain, and the reference power using reference power (dBm)−reference correlation gain (dB)+correlation gain (dB) (step S17). As a result, the processor 24 can calculate the PIM power amount that is the generation amount of the PIM signal even during operation. The processor 24 outputs the calculated PIM power amount (step S18) and ends the processing operation illustrated in FIG. 6. The processor 24 outputs the estimated PIM power amount by broadcast or notifies the CU/DU 2 of the estimated PIM power amount. The carrier operator of the CU/DU 2 can confirm the PIM power amount of the RU 3 during operation.

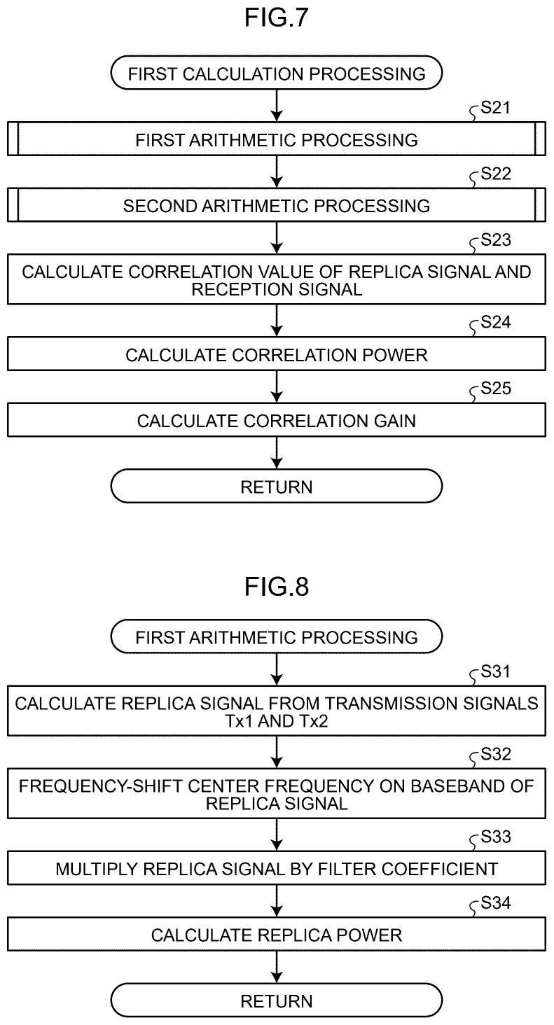

FIG. 7 is a flowchart illustrating an example of a processing operation of the processor 24 in the RU 3 related to the first calculation processing. In FIG. 7, the calculation unit 48 in the processor 24 executes first arithmetic processing of calculating the replica signal (step S21). The processor 24 executes second arithmetic processing of calculating the reception signal (step S22).

The correlation arithmetic unit 54 in the processor 24 calculates a correlation value between the replica signal and the reception signal (step S23). The correlation arithmetic unit 54 calculates correlation power based on the calculated correlation value (step S24). The correlation arithmetic unit 54 calculates a correlation gain from the calculated correlation power (step S25) and ends the processing operation illustrated in FIG. 7.

FIG. 8 is a flowchart illustrating an example of a processing operation of the processor 24 in the RU 3 related to the first arithmetic processing. In FIG. 8, the replica calculation unit 51 in the processor 24 calculates a replica signal from the transmission signals Tx1 and Tx2 (step S31). The frequency shift unit 52 in the processor 24 frequency-shifts a center frequency on a baseband of the calculated replica signal (step S32). Note that the center frequency of the replica signal is frequency-shifted to be aligned with a center frequency of the reception signal.

The multiplication unit 53 in the processor 24 multiplies the replica signal after frequency shift by the filter coefficient (step S33). The correlation arithmetic unit 54 in the processor 24 calculates replica power according to the replica signal after multiplication (step S34) and ends the processing operation illustrated in FIG. 8. Note that the replica power is used when calculating the correlation gain by (Formula 9).

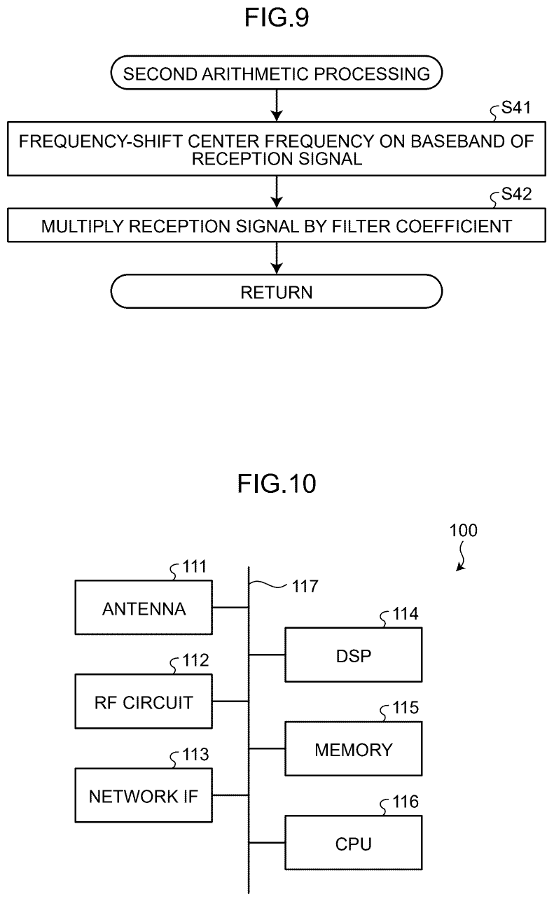

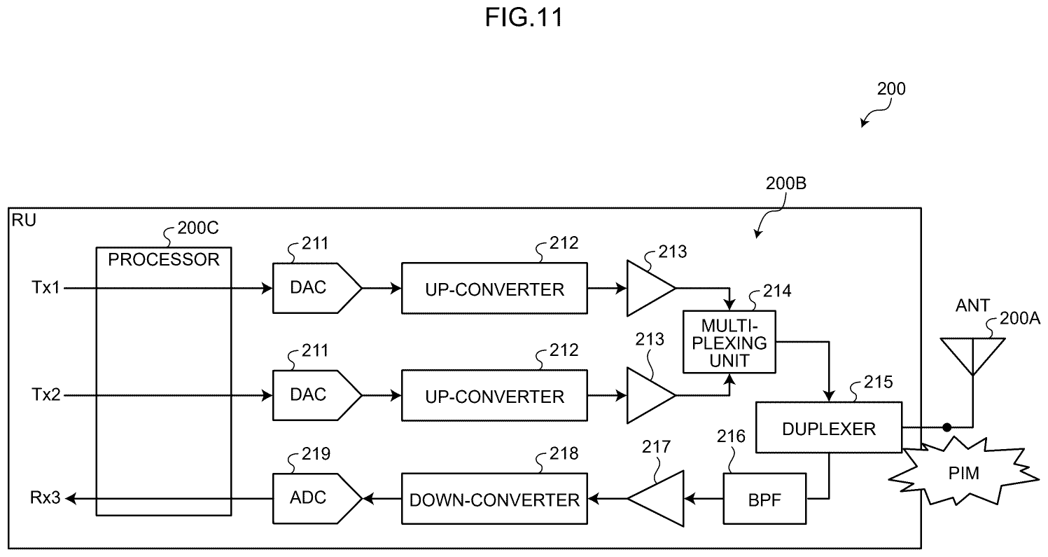

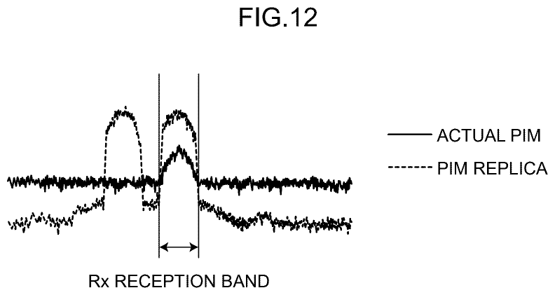

FIG. 9 is a flowchart illustrating an example of a processing operation of the processor 24 in the RU 3 related to the second arithmetic processing. In FIG. 9, the frequency shift unit 52 in the processor 24 frequency-shifts a center frequency on a baseband of the reception signal (step S41). Note that the center frequency of the reception signal is frequency-shifted to be aligned with a center frequency of the replica signal. The multiplication unit 53 in the processor 24 multiplies the reception signal after frequency shift by the filter coefficient (step S42) and ends the processing operation illustrated in FIG. 9.

The RU 3 of the present embodiment generates the replica signal of the PIM signal based on the plurality of transmission signals and calculates the correlation gain based on the correlation between the replica signal and the reception signal. The RU 3 estimates the generation amount of the PIM signal based on the calculated correlation gain, the reference power, and the reference correlation gain. As a result, the generation amount of the PIM signal can be monitored even during operation. That is, when the RU 3 notifies the CU/DU 2 of the generation amount of the PIM signal, the carrier operator of the CU/DU 2 can confirm the generation amount of the PIM signal during operation, so that it is possible to take measures to prevent sensitivity deterioration in the reception signal due to the PIM signal and influence on uplink characteristics.

The RU 3 multiplies both the replica signal and the reception signal by the filter coefficient for cutting band components other than the reception band. Then, the RU 3 calculates the correlation gain of the reception band based on the replica signal after multiplication and the reception signal after multiplication. That is, the band components other than the reception band are restricted, and influence of the filter in an analog circuit such as the duplexer 35 or the BPF 36 is excluded. As a result, accuracy of calculating the correlation between the replica signal and the reception signal is improved, and accuracy of estimating the generation amount of the PIM signal is improved.

The RU 3 calculates the reference correlation gain based on the correlation between the replica signal and the reception signal obtained under the training environment in which a predetermined PIM signal is generated, and stores the calculated reference correlation gain in the memory 23. As a result, it is possible to acquire the reference correlation gain in the predetermined PIM signal in advance to use for calculating the generation amount of the PIM signal.

The RU 3 stores a subtraction result in the memory 23, the result being obtained by subtracting noise power of the reception circuit from reception power corresponding to the reception signal obtained under the training environment in which the predetermined PIM signal is generated as the reference power. As a result, it is possible to acquire the reference power in the predetermined PIM signal in advance to use for calculating the generation amount of the PIM signal.

The RU 3 calculates the correlation gain for each delay difference, and selects the correlation gain having the maximum value from the calculated correlation gains for each delay difference. The RU 3 estimates the generation amount of the PIM signal based on the reference power, the reference correlation gain, and the selected correlation gain of the delay difference. As a result, the generation amount of the PIM signal can be monitored even during operation.

Measurement of the generation amount of the PIM signal is to be performed in an environment in which signals other than the PIM signal are not input, but the generation amount of the PIM signal was not easily grasped during operation of the RU 3. Meanwhile, in the present embodiment, since the generation amount (power) of the PIM signal is estimated from the correlation value between the replica signal and the reception signal of the PIM, the generation amount of the PIM signal can be estimated even under an environment in which uncorrelated signals such as uplink signals or external noises are input.

Note that, for convenience of description, one RU 3 connected to the CU/DU 2 in the radio system 1 is exemplified, but a plurality of RU 3 may be used, and the number of RUs can be appropriately changed.

In the present embodiment, the processor 24 in the RU 3 being caused to execute the estimation processing is exemplified, but the processor 13 in the CU/DU 2 may be caused to execute the estimation processing and an appropriate change can be applied to the embodiment. When a PIM cancellation device that cancels the PIM signal of the reception signal is disposed between the CU/DU 2 and the RU 3, a processor in the PIM cancellation device may be caused to execute the estimation processing and an appropriate change can be applied to the embodiment.

FIG. 10 is an explanatory diagram illustrating an example of a hardware configuration of an RU 100. The RU 100 illustrated in FIG. 10 includes an antenna 111, a radio frequency (RF) circuit 112 including the antenna 111, a network interface (IF) 113, and a DSP 114 as hardware components. The RU 100 also includes a memory 115, a CPU 116, and a bus 117. The CPU 116 is connected via the bus 117 to be able to input and output various signals and data signals. The memory 115 includes, for example, at least one of a RAM such as a synchronous dynamic random access memory (SDRAM), a read only memory (ROM), and a flash memory, and stores a program or the like for controlling processing of the RU 100.

The RU 3 illustrated in FIG. 2 is realized by, for example, the antenna 111, the RF circuit 112, the network IF 113, the DSP 114, the memory 115, and the CPU 116. For example, in the RU 3, a part of digital processing is implemented by the DSP 114, and processing of radio signal is implemented by the RF circuit 112. For example, the operation of the RU 3 is controlled in response to control of the CPU 116. The network IF 113 is used to transmit and receive, for example, signals and the like from the CU/DU 2.

In each embodiment, the estimation processing is performed by the processor 24 of the RU 3, but the estimation processing may be performed by the processor 13 of the CU/DU 2 and an appropriate change can be applied to the embodiment.

The estimation processing described in each embodiment can also be implemented as a computer-executable program. Here, the program can be stored in a computer-readable recording medium and be introduced into the computer. Examples of the computer-readable recording medium include a portable recording medium such as a CD-ROM, a DVD, or a USB memory, and a semiconductor memory such as a flash memory.

In one aspect, a generation amount of an intermodulation distortion signal can be monitored even during operation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A radio communication apparatus comprising:
a transmission signal acquisition unit that acquires a plurality of transmission signals wirelessly transmitted at different frequencies;
a reception signal acquisition unit that acquires a reception signal;
a storage unit that stores reference power and a reference correlation gain;
a calculation unit that generates a replica signal of an intermodulation distortion signal based on the plurality of transmission signals and calculates a correlation gain based on a correlation between the replica signal and the reception signal; and
an estimation unit that estimates the intermodulation distortion signal based on the correlation gain calculated by the calculation unit and the reference power and the reference correlation gain stored in the storage unit.

2. The radio communication apparatus according to claim 1, wherein the calculation unit includes,
a multiplication unit that multiplies both the replica signal and the reception signal by a filter coefficient for cutting band components other than a reception band, and
a correlation arithmetic unit that calculates a correlation gain of the reception band based on the replica signal after multiplication and the reception signal after multiplication.

3. The radio communication apparatus according to claim 1, wherein
the calculation unit calculates the reference correlation gain based on a correlation between the replica signal and the reception signal obtained under an environment in which a predetermined intermodulation distortion signal is generated, and stores the calculated reference correlation gain in the storage unit.

4. The radio communication apparatus according to claim 3, wherein
the reception signal acquisition unit subtracts noise power of a reception circuit from reception power corresponding to the reception signal obtained under the environment in which the predetermined intermodulation distortion signal is generated, and stores a subtraction result as the reference power in the storage unit.

5. The radio communication apparatus according to claim 1, wherein
the calculation unit calculates the correlation gain for each delay difference, and
the estimation unit includes,
a selection unit that selects a correlation gain having a maximum value among the calculated correlation gain for each delay difference, and
an arithmetic unit that estimates the intermodulation distortion signal based on the reference power, the reference correlation gain, and the selected correlation gain of the delay difference.

6. The radio communication apparatus according to claim 1, wherein
the estimation unit estimates the intermodulation distortion signal by subtracting the reference correlation gain from the reference power and adding the correlation gain to the reference power after subtraction.

7. An estimation method of causing a radio communication apparatus that transmits a transmission signal to a radio terminal apparatus and receives a reception signal from the radio terminal apparatus to execute a process comprising:
acquiring a plurality of transmission signals wirelessly transmitted at different frequencies;
acquiring a reception signal;
storing reference power and a reference correlation gain in advance;
generating a replica signal of an intermodulation distortion signal based on the plurality of transmission signals and calculating a correlation gain based on a correlation between the replica signal and the reception signal; and
estimating the intermodulation distortion signal based on the calculated correlation gain and the stored reference power and reference correlation gain.

8. The estimation method according to claim 7, wherein calculating the correlation gain includes,
multiplying both the replica signal and the reception signal by a filter coefficient for cutting band components other than a reception band, and
calculating a correlation gain of the reception band based on the replica signal after multiplication and the reception signal after multiplication.

9. The estimation method according to claim 7, wherein storing the reference correlation gain includes,
calculating the reference correlation gain based on a correlation between the replica signal and the reception signal obtained under an environment in which a predetermined intermodulation distortion signal is generated, and
storing the calculated reference correlation gain.

10. The estimation method according to claim 9, wherein storing the reference power includes
subtracting noise power of a reception circuit from reception power corresponding to the reception signal obtained under the environment in which the predetermined intermodulation distortion signal is generated, and storing a subtraction result as the reference power.

11. The estimation method according to claim 7, wherein
calculating the correlation gain includes calculating the correlation gain for each delay difference, and
estimating the intermodulation distortion signal includes,
selecting a correlation gain having a maximum value among the calculated correlation gain for each delay difference, and
estimating the intermodulation distortion signal based on the reference power, the reference correlation gain, and the selected correlation gain of the delay difference.

12. The estimation method according to claim 7, wherein estimating the intermodulation distortion signal includes,
subtracting the reference correlation gain from the reference power, and
estimating the intermodulation distortion signal by adding the correlation gain to the reference power after subtraction.
